(19) United States
(12) Patent Application Publication
(10) Pub. No.: US 2019/0055141 A1
(43) Pub. Date: Feb. 21, 2019

(54) Large Salinity Electrodialysis Desalination

(71) Applicant: Ben Harrison Cantrell, Springfield, VA (US)

(72) Inventor: Ben Harrison Cantrell, Springfield, VA (US)

(21) Appl. No.: 15/678,799

(22) Filed: Aug. 16, 2017

(51) Int. Cl. C02F 1/469; B01D 61/46

(52) U.S. Cl. CPC C02F 1/4693; B01D 61/025; B01D 61/46

(57) ABSTRACT

The concentrated and dilute saline water distribution systems of Electro Dialysis Reversal EDR or Capacitive Electro Dialysis Reversal CEDR are modified by feeding and retrieving the saline water to and from multiple spacers in an electrodialysis stack such that (1) the saline water enters and leaves the spacers in the plane of the thin spacers rather than traditionally perpendicular to them and (2) the saline waters are independently fed and retrieved to and from the spacers through long and small cross-sectional area tubes such that the electrical resistance to ion flow is very high relative to the electrical resistance to ion flow through the electrodialysis stack containing the cation and anion exchange membranes and dilute and concentrated saline water spacers. Consequently, little ion flow will occur in the saline water distribution systems and consequently most of the ions flow through the electrodialysis stack of EDR or CEDR providing effective desalination regardless of the salinity levels of the feed waters.

### CROSS-REFERENCE TO RELATED APPLICATIONS

Not Applicable

### FEDERALLY SPONSORED RESEARCH OR DEVELOPMENT

Not applicable

### REFERENCE TO A “SEQUENCE LISTING”

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND

### Field of the Invention

This invention is in the field of desalination and waste disposal of desalination waste products.

### Description of the Related Art

There are large quantities of modestly saline water stored in aquifers, but whose salinity exceeds safe levels for use. This modestly saline water, having salinities on the order of 500 ppm to 5,000 ppm, could be used if an affordable means of lowing its salinity and disposing of the waste saline water could be found. Both well-known reverse osmosis RO and Electro Dialysis Reversal EDR processes can desalinate this saline water. However, the salinity of the waste water from these processes is limited to be considerably below saturation and consequently the quantity of waste saline water is quite large. This invention provides a means of desalinating saline feed water with a modified EDR process such that the waste saline water's salinity can be near saturation. Thus, the amount of waste saline water would be reduced from that of the traditional desalination processes of RO and EDR. Beyond this modified EDR capability, the feed saline water's salinity for this invention can even be from low to high while the waste saline water's salinity approaches saturation. Because of this property, this invention could be used either as a saline water desalination or concentration process. Examples of saline water concentration processes are: (a) concentrate the waste saline water from an RO process and (b) be part of a process to form solid salt.

The basic EDR operation can be found in Non-Patent Literature Document [1] and is described as follows. First, an EDR electrodialysis stack is defined as a stack of alternating cation exchange membranes and anion exchange membranes separated with spacers carrying alternately dilute and concentrated saline water. Furthermore, the electrodialysis stack has inert electrodes on each end which are connected to the positive and negative terminals of a DC power supply. The DC power supply connected to the inert electrodes form an electric field through the electrodialysis stack which then applies forces followed by subsequent motion to the ions through the concentrated saline water, dilute saline water, cation exchange membranes, and anion exchange membranes. Consider anyone of the concentrated saline water spacers containing concentrated saline water which have two adjacent dilute saline water spacers containing dilute saline water. Cations are driven in one direction from the dilute saline water contained in one of the adjacent dilute saline water spacers through a cation exchange membrane into the concentrated saline water contained in the centrally located concentrated saline water spacer and the anions are driven in the other direction from the dilute saline water contained in the other adjacent dilute saline water spacer through an anion exchange membrane into the concentrated saline water contained in that same centrally located concentrated saline water spacer. In this way, the concentrated saline water in the concentrated saline water spacers gain both cations and anions from the two-adjacent dilute saline water spacers containing dilute saline water which makes the concentrated saline water spacer's saline water more saline and makes the dilute saline water spacer's saline water less saline. Next consider anyone of the dilute saline water spacers containing dilute saline water which have two adjacent concentrated saline water spacers containing concentrated saline water. Cations are driven out of the dilute saline water contained in the centrally located dilute saline water spacer in one direction through the cation exchange membrane into the concentrated saline water contained in one of the adjacent concentrated saline water spacers and the anions are driven out of the dilute saline water contained in the centrally located dilute saline water spacer in the other direction through the anion exchange membrane into the concentrated saline water contained in the other adjacent concentrated saline water spacer which makes the dilute saline water spacer's saline water less saline and makes the concentrated saline water spacer's saline water more saline. However, this process is interrupted at each end of the EDR electrodialysis stack where the electrodes are located because there are no adjacent ion exchange membrane and saline water to continue the process. Consequently, an electrochemical process takes place at the inert electrodes where a gas is formed at one inert electrode by providing electrons to the ions and a different gas is formed at the other inert electrode by the electrode absorbing electrons from the ions. Some forms of EDR electrodialysis stacks always have cation exchange membranes nearest the inert electrodes.

The basic EDR process can be modified to operate with supercapacitor electrodes so that no gases are formed at these electrodes as described in Non-Patent Literature Document [2]. This modified EDR process is called Capacitive Electrodialysis Reversal EDR. In this case there are two separate electrodialysis stacks rather than one in which each separate electrodialysis stack has supercapacitors as electrodes. These two parallel electrodialysis stacks' electrodes are operated with opposite voltages and currents. The two electrodialysis stacks are operated just like EDR while the supercapacitors charge. When they are fully charged, the supercapacitor electrodes at each end of the two stacks are exchanged and the process starts again. After the supercapacitors are exchanged, the discharging and charging supercapacitors continue to send the ions in the proper direction to maintain the ions flowing from the dilute saline water contained in the dilute saline water spacers to the concentrated saline water contained in the concentrated saline water spacers. The basic operations and construction of this modified EDR called Capacitive Electro Dialysis Reversal CEDR are very similar in many respects to EDR.

Even if the EDR or CEDR systems can operate with dilute and concentrated saline water having large salinities and even up to near saturation, the process that feeds saline waters to the units must provide the operation which will highly concentrate the waste saline water while operating on much lower salinity feed waters to desalinate them. A process in Non-Patent Literature Document [3] describes a means of achieving this. The process recirculates the concentrated saline waste water through either the EDR or CEDR systems while new input dilute saline water is fed into them. A small amount of salt is extracted from the feed dilute saline water as it is processed and this salt is sent to the recirculating concentrated saline waste water through the action of the EDR or CEDR systems. Over time, a large amount of salt is eventually extracted from a large amount of dilute saline feed water that is processed and this large amount of salt will make the concentrated saline water being recirculated very saline. Finally, the waste concentrated saline water becomes nearly fully saturated and is emptied. Then the process starts all over. Finally, if the concentrated saline waste water solution has a metastable zone where the solution can be supersaturated, then this invention can be used to supersaturate the solution given no precipitation has occurred and solid wastes can be generated as described in Non-Patent Literature Document [4].

The description of the invention starts by describing the EDR processes and the problems they have operating with high salinities. A means of modifying traditional EDR or CEDR systems so they can effectively perform desalination or concentration operations, even if the dilute product and concentrated waste saline waters have very high salinities, is then described. These modifications to EDR and CEDR is the invention.

### BRIEF SUMMARY OF THE INVENTION

In EDR systems, both the dilute and the concentrated saline waters are fed from front-to-back through the electrodialysis stack and a portion of each water type is diverted through the appropriate dilute or concentrated saline water spacers along the paths. In a like manner, the dilute and concentrated saline waters flowing into, through, and out of the appropriate dilute and concentrated saline water spacers is appropriately added to the recovered dilute and concentrated saline waters flowing from front-to-back through the electrodialysis stack. This arrangement causes the concentrated saline water paths to be very short between like concentrated saline water spacers carrying concentrated saline water. When the concentrated saline water becomes very saline, the electrical resistance to ion flow can become low in the concentrated saline water distribution system. Consequently, substantial number of ions can flow in the concentrated saline water distribution system rather than flow through the electrodialysis stack containing the cation and anion exchange membranes. Therefore, the ability of the EDR system to desalinate saline water is reduced. A similar problem occurs in the dilute saline water distribution system, but it is not as pronounced as in the concentrated saline water distribution system because its salinity is typically lower that the concentrated saline water.

This invention feeds and recovers the concentrated saline water to, through, and out of like spacers using long small cross-sectional area tubes that enters and leaves the spacers through the thin sides of the spacers rather than through the electrodialysis stack from front-to-back. This arrangement makes the electrical resistance to ion flow very high so that there will be little ion flow in the concentrated saline water distribution system. Consequently, almost all the ions will flow through the electrodialysis stack containing the cation and anion exchange membranes. Therefore, there is little effect on desalination even if the concentrated saline water approaches saturation. Although the dilute saline water distribution system is not as much as an issue, it can be constructed in the same manner as the concentrated saline water distribution system. This invention can be used to directly desalinate saline water and have waste saline water that is nearly saturated or it can be used to highly concentrate the waste saline water from other desalination processes such as reverse osmosis. Finally, if the concentrated saline water has a metastable zone where the solution can be supersaturated, but where no precipitation has yet occurred, this invention can be used to create solid wastes as well.

### BRIEF DESCRIPTION OF THE SEVERAL VIEWS OF THE DRAWING(S)

FIG. 1: Illustration of how the ions flow in a traditional EDR electrodialysis stack

FIG. 2: Illustration of the components of a traditional EDR electrodialysis stack showing how the input dilute and concentrated saline water is distributed from front-to-back through the traditional EDR spacers and showing how the output dilute and concentrated saline water, after flowing through the spacers, is recovered from front-to-back from the traditional EDR spacers

FIG. 3: Illustration of how a portion of the dilute saline water flows through a traditional EDR dilute saline water spacer

FIG. 4: Illustration of how a portion of the concentrated saline water flows through a traditional EDR concentrated saline water spacer

FIG. 5: Illustration of how the ions can flow, not only through the cation and anion exchange membranes, but also between the concentrated saline spacers through the concentrated saline water distribution system for a traditional EDR system

FIG. 6: Illustration of how concentrated saline water can be fed through long small cross-sectional area tubes into the thin side of a concentrated saline water spacer. Likewise, concentrated saline water can be recovered through long small cross-sectional area tubes from the opposite thin side of a concentrated saline water spacer

FIG. 7: Illustration of how concentrated saline water can be fed through long small cross-sectional area tubes into the thin sides of multiple concentrated saline water spacers. Likewise, concentrated saline water can be recovered through long small cross-sectional area tubes from the opposite thin sides of multiple concentrated saline water spacers. The other components, which are cation and anion exchange membranes, dilute saline water spacers, and end electrodes, of the modified EDR electrodialysis stack are not shown, but their placement in the stack would be the same as shown in FIG. 2.

FIG. 8: Illustration of how dilute saline water can be fed through long small cross-sectional area tubes into the thin side of a dilute saline water spacer. Likewise, dilute saline water can be recovered through long small cross-sectional area tubes from the opposite thin side of a dilute saline water spacer.

FIG. 9: Illustration of how dilute saline water can be fed through long small cross-sectional area tubes into the thin sides of multiple dilute saline water spacers. Likewise, dilute saline water can be recovered through long small cross-sectional area tubes from the opposite thin sides of multiple dilute saline water spacers. The other components, which are cation and anion exchange membranes, concentrated saline water spacers, and end electrodes, of the modified EDR electrodialysis stack are not shown, but their placement in the stack would be the same as shown in FIG. 2.

FIG. 10: Illustration of a short electrodialysis stack of a modified EDR system using cation exchange membranes, anion exchange membranes, electrodes, and this invention's (a) dilute and concentrated saline water spacers and (b) long small cross-sectional area tubes as shown in FIGS. 7 and 9.

FIG. 11: Illustration of how concentrated saline water can be fed through long small cross-sectional area tubes into the thin sides of multiple concentrated saline water spacers for a CEDR system. Likewise, concentrated saline water can be recovered through long small cross-sectional area tubes from the opposite thin sides of multiple concentrated saline water spacers for a CEDR system. The other components, which are cation and anion exchange membranes, dilute saline water spacers, and end electrodes, of the modified CEDR electrodialysis stack are not shown, but their placement in the stack would be similar that of FIG. 2.

### DETAILED DESCRIPTION OF THE INVENTION

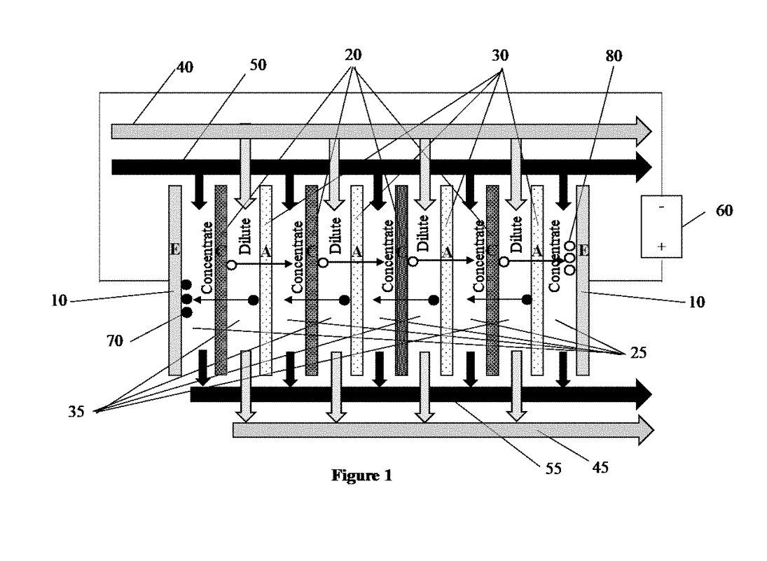

The construction and operation of a traditional Electrodialysis Reversal EDR system and this invention's modified EDR system are both described. FIG. 1 illustrates the operation of one form of a traditional EDR system that desalinates saline water. Cation and anion exchange membranes 20 and 30 along with dilute and concentrated saline water spacers 35 and 25 are arranged in an electrodialysis stack that have inert electrodes 10 at each end of the stack. Dilute saline water 40 enters the alternating dilute saline water spacers 35, flows through them, and the dilute saline water 45 exits the other end. Concentrated saline water 50 enters the alternating concentrated saline water spacers 25, flows through them, and the concentrated saline water 55 exits the other end. The dilute saline water path 40 to 45 and the concentrated saline water path 50 to 55 are completely separate. An electric field is applied through the electrodialysis stack by applying a DC power supply 60 to the inert electrodes 10 located at each end of the electrodialysis stack. The electric field will provide a force and then subsequent motion to the cations 70 and anions 80. However, the cation exchange membranes 20 can only pass cations 70 and not anions 80 while the anion exchange membranes 30 can only pass anions 80 and not cations 70. Consequently, in the interior of the electrodialysis stack, the cations 70 leave the dilute saline water located in the dilute saline water spacers 35, pass through the cation exchange membranes 20, and then enter into the concentrated saline water located in the concentrated saline water spacers 25. Likewise, in the interior of the electrodialysis stack, the anions 80 leave the dilute saline water located in the dilute saline water spacers 35, pass through the anion exchange membranes 30, and then enter into the concentrated saline water located in the concentrated saline water spacers 25. This process of anion 80 and cation 70 motion continues while new saline waters enter and leave the electrodialysis stack so that ions do not entirely deplete or build up in the region of the dilute and concentrated saline water spacers 35 and 25. However, this process of ion motion does not occur at the inert electrodes. To complete the circuit so that the ion current will flow continuously, gasses are formed at the inert electrodes where one inert electrode absorbs electrons and the other inert electrode provides electrons for the electrochemical reaction. This EDR process removes ions from the dilute saline water, which is defined as a desalination process, by transferring ions to the concentrated saline water which becomes more saline and is the waste water from the desalination process.

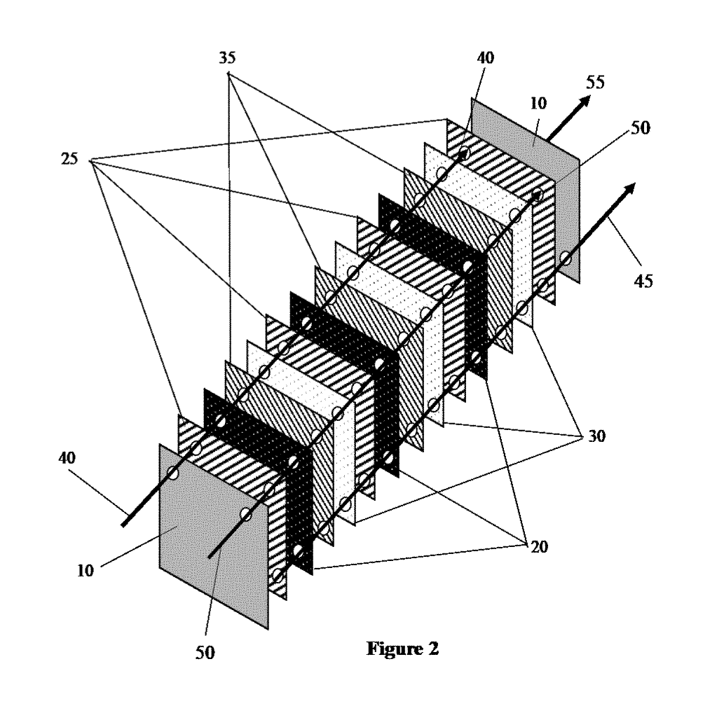

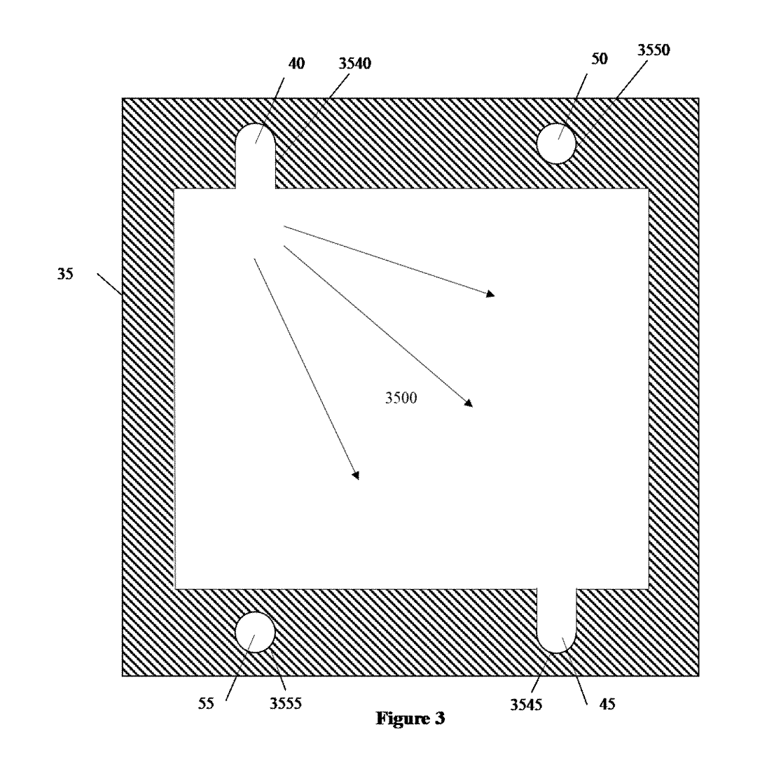

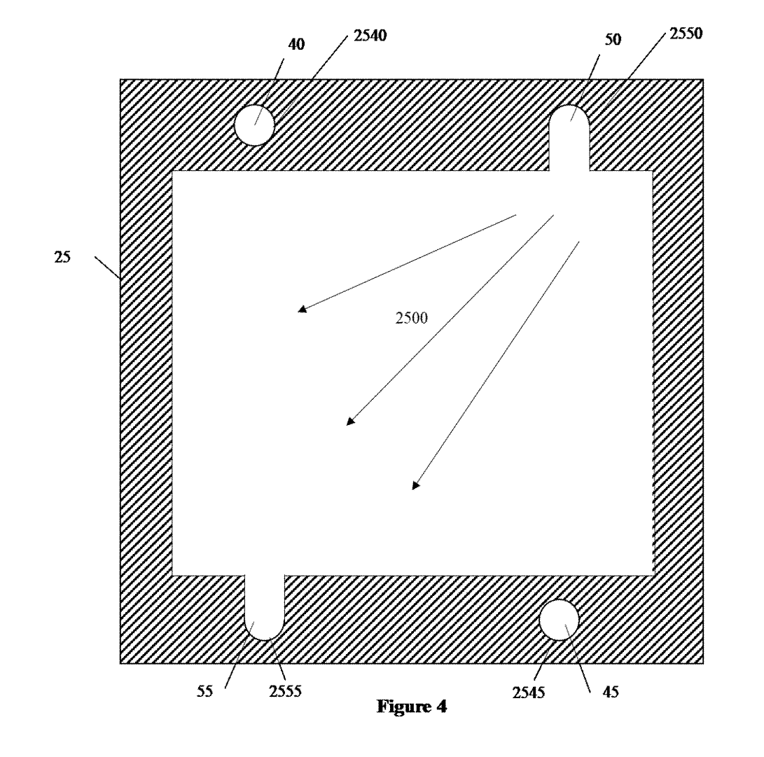

FIG. 2 illustrates the construction of a traditional EDR system. Cation exchange membranes 20, black background with white dot, and anion exchange membranes 30, white background with black dots, are alternately placed in the electrodialysis stack. But between alternating sets of cation and anion exchange membranes 20 and 30, there are concentrated saline water spacers 25, diagonal lines slanted to the right, that can carry concentrated saline water. Furthermore, between oppositely alternating sets of cation and anion exchange membranes 20 and 30, there are dilute saline water spacers 35, diagonal lines slanted to the left, that can carry dilute saline water. All the cation and anion exchange membranes 20 and 30 and the dilute and concentrated saline water spacers 25 and 35 are all relatively thin compared to their cross-sectional area. Dilute saline water 40 enters from the front of the electrodialysis stack at the front inert electrode 10, travels through the cation and anion exchange membranes 20 and 30 and the dilute and concentrated saline water spacers 25 and 35 from front-to-back down the length of the electrodialysis stack except it does not exit at the rear inert electrode 10. However, some of this dilute saline water flow is coupled off at each dilute saline water spacer 35, flows through the dilute saline water spacer 35, as shown in FIG. 3, exists into another dilute water channel 45 that travels through the cation and anion exchange membranes 20 and 30 and the dilute and concentrated saline water spacers 25 and 35 from front-to-back down the length of the electrodialysis stack, and finally exists out of the rear of the electrodialysis stack at the rear inert electrode 10. Similarly, concentrated saline water 50 enters from the front of the electrodialysis stack at the front electrode 10, travels through the cation and anion exchange membranes 20 and 30 and the dilute and concentrated saline water spacers 25 and 35 from front-to-back down the length of the electrodialysis stack except it does not exit at the rear inert electrode 10. However, some of this concentrated saline water flow is coupled off at each concentrated saline water spacer 25, flows through the concentrated saline water spacer 25, as shown in FIG. 4, exists into another concentrated water channel 55 that travels through the cation and anion exchange membranes 20 and 30 and the dilute and concentrated saline water spacers 25 and 35 from front-to-back down the length of the electrodialysis stack, and finally exists out of the rear of the electrodialysis stack at the rear inert electrode 10. Most of the output concentrated saline water 55 is hidden from view. A DC power supply, that is not shown, provides power to the front and rear electrodes 10.

Some detail of how the dilute and concentrated saline water flows through the dilute and concentrated saline water spacers 35 and 25 are provided in FIGS. 3 and 4 for traditional EDR systems. The dilute saline water spacer 35, which is thin relative to its cross-sectional area, is shown in FIG. 3. There is a large open surface area 3500 in the center of the dilute saline water spacer 35. The walls of the dilute saline water spacer 35 will be created by the cation and anion exchange membranes 20 and 30 and the resulting closed volume cavity contains the dilute saline water flowing through it. There are closed holes 3550 and 3555 in the dilute saline water spacer 35 so the input concentrated saline water 50 and the output concentrated saline water 55 can pass perpendicularly through it without mixing with the dilute saline water 40 to 45 passing through the cavity in the dilute saline water spacer 35. There are opened holes 3540 and 3545 in the dilute saline water spacer 35 so the input dilute saline water 40 and output dilute saline water 45 can pass into and out of the cavity 3500 as well as pass on perpendicularly through the electrodialysis stack. The direction of the dilute saline water flow from hole 3540 to hole 3545 within the dilute saline water spacer 35 is illustrated with the arrows in the cavity 3500.

The concentrated saline water spacer 25, which is thin relative to its cross-sectional area, is shown in FIG. 4. There is a large open surface area 2500 in the center of the concentrated saline water spacer 25. The walls of the concentrated saline water spacer 25 will be created by the cation and anion exchange membranes 20 and 30 and the resulting closed volume cavity contains the concentrated saline water flowing through it. There are closed holes 2540 and 2545 in the concentrated saline water spacer 25 so the input dilute saline water 40 and the output dilute saline water 45 can pass perpendicularly through it without mixing with the concentrated saline water 50 to 55 passing through the cavity in the concentrated saline water spacer 25. There are opened holes 2550 and 2555 in the concentrated saline water spacer 25 so the input concentrated saline water 50 and output concentrated saline water 55 can pass into and out of the cavity 2500 as well as pass on perpendicularly through the electrodialysis stack. The direction of the concentrated saline water flow from hole 2550 to hole 2555 within the concentrated saline water spacer 25 is illustrated with the arrows in the cavity 2500.

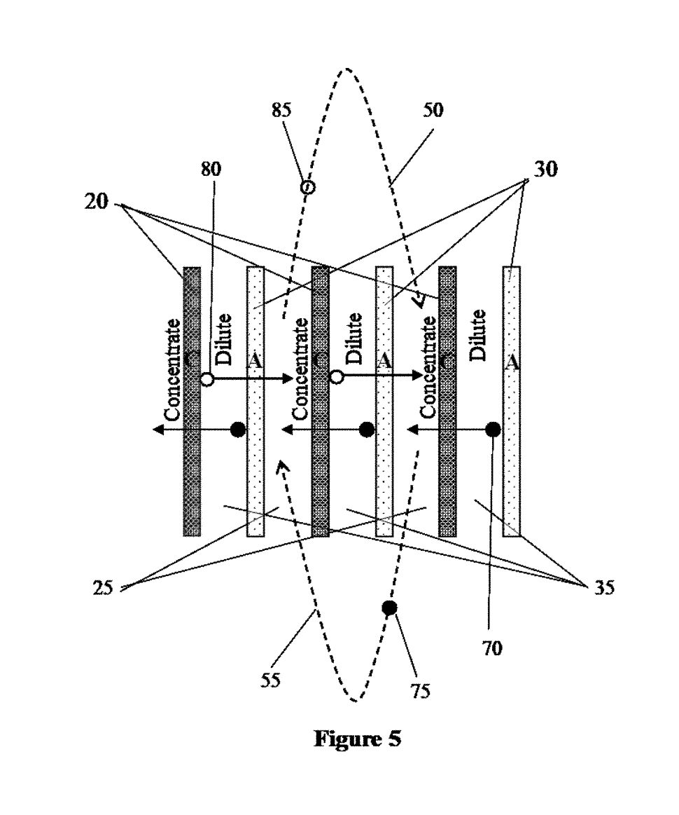

FIG. 5, which repeats a portion of the electrodialysis stack shown in FIG. 1, illustrates the issues of operating the EDR system when the saline water's salinity become high. The location of the dilute saline water spacers 35 containing the dilute saline water between the cation exchange membranes 20 and anion exchange membranes 30 is shown. The concentrated saline water spacers 25 containing the concentrated saline water are located on each side of the cation and anion exchange membranes 20 and 30 respectively whose surfaces are adjacent to the dilute saline water contained in the dilute saline water spacer 35. The motion of the cations 70, indicated by solid black dots, is from the dilute saline water located in dilute saline water spacer 35 to the concentrated saline water located in concentrated saline water spacer 25 through the cation exchange membrane 20. The motion of the anions 80, indicated by circles, is from the dilute saline water located in dilute saline water spacer 35 to the concentrated saline water located in the other concentrated saline water spacer 25 through the anion exchange membrane 30. This is the normal desired operation. However, the concentrated saline water flowing into and out of all the concentrated saline water spacers 25 illustrated by dotted lines 50 and 55 also provides a path for cations 75 and anions 85 to flow respectively from one concentrated saline water spacer 25 to another as illustrated with dotted lines in FIG. 5. In fact, the ion current can be flowing everywhere in the concentrated saline water distribution system. If the concentrated saline water becomes very saline, the electrical resistance to ion flow in the concentrated saline water distribution system can be comparable to or even lower than the electrical resistance to ion flow through the cation exchange membrane 20, anion exchange membrane 30, and the dilute saline water contained in the dilute saline water spacer 35. Thus, a portion of the electrical current could flow through the cation and anion exchange membranes 20 and 30 respectively while the other portion of the ion current could flow through the concentrated saline water distribution system. Furthermore, some of the applied power would then be used for desalination while the other portion of the applied power would just be used up as heat due to the ion current flowing in the concentrated saline water distribution system. Thus, the EDR system capability to desalinate saline water would be diminished. A similar situation would also occur in the dilute saline water distribution system but would be less pronounced because of its lower salinity.

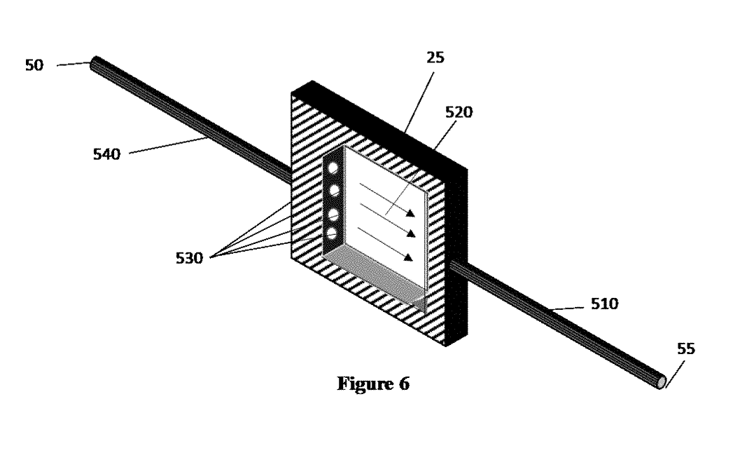

This invention provides a construction variation to traditional EDR systems that will significantly increases the electrical resistance to the ion flow in the dilute and concentrated saline water distribution systems that provide dilute and concentrated saline waters and to and from the dilute and concentrated saline water spacers respectively in the electrodialysis stack. FIG. 6 shows how the concentrated saline water 50 and 55 is provided to and from a single concentrated saline water spacer 25. The concentrated saline water spacer 25 is again fairly thin relative to its cross-sectional area and has a large thin cavity in its center for the concentrated saline water to flow through it. Concentrated saline water 50 enters a long and small cross-sectional area tube 540, enters the concentrated saline water spacer 25 through its thin side wall, and is distributed internally within the walls of the concentrated saline water spacer 25 to holes 530 that enter into the cavity of the concentrated saline water spacer 25. The concentrated saline water 520 flows from the holes 530 in the far wall of the concentrated saline water spacer 25 to like holes 530, not shown, on the opposite side of the concentrated saline water spacer 25. After, the concentrated saline water enters the holes 530 on the near wall, not shown, it is combined within the concentrated saline water spacer 25, exits the concentrated saline water spacer 25 in a like manner as the input concentrated saline water enters and then out through the long and small cross-sectional area tube 510 as the output concentrated saline water 55. The electrical resistance of the saline concentrated saline water in the tubes to ion flow, which is given by the resistivity of the saline water times the tube length divided by the cross-sectional area of the tubes 510 and 540, can be made very high by proper choice of the parameters. If the electrical resistance between any two concentrated saline water spacers in the electrodialysis stack is much lower than the electrical resistance of the concentrated saline water through the tubes 510 and 540 for any desired salinity level, then the salinity of the concentrated saline water does not materially affect the desalination as it can in the current traditional construction methods of EDR systems.

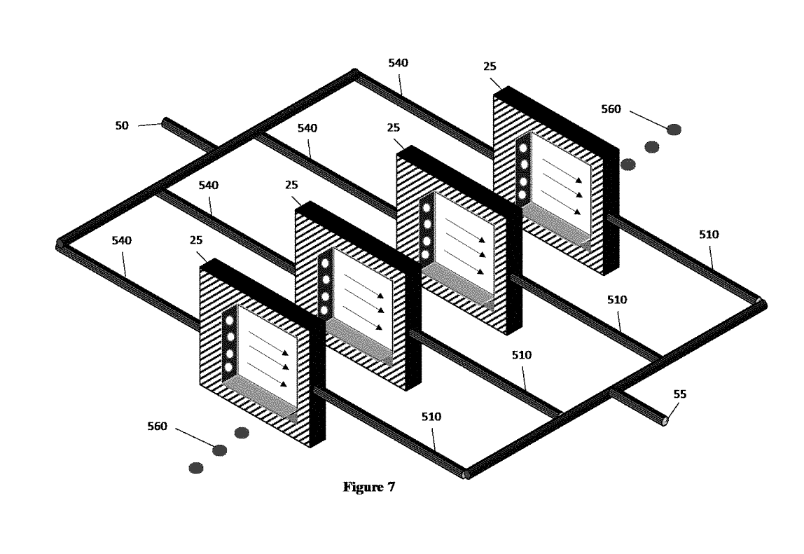

In a modified EDR electrodialysis stack, the concentrated saline water 50 and 55 enters and exits multiple identical concentrated saline water spacers 25 through long and small cross-sectional area tubes 510 and 540 as shown in FIG. 7. Only the concentrated saline water distribution of the electrodialysis stack is illustrated. The cation exchange membranes, anion exchange membranes, and the dilute saline water spacers that would be between each pair of concentrated saline water spacers 25 in an electrodialysis stack are not shown. The dotted regions 560 indicates that the arrangement of concentrated saline water spacers 25 continue on until the electrode regions of the electrodialysis stack is reached.

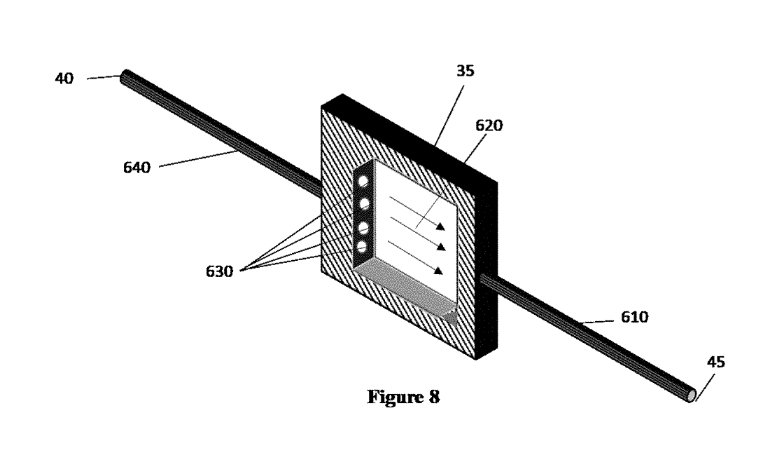

FIG. 8 shows how the dilute saline water 40 and 45 is provided to and from a single dilute saline water spacer 35 and is identical in form to the concentrated saline water spacer shown in FIG. 6. The dilute saline water spacer 35 is again fairly thin relative to its cross-sectional area and has a large thin cavity in its center for the dilute saline water to flow through it. Dilute saline water 40 enters a long and small cross-sectional area tube 640, enters the dilute saline water spacer 35 through its thin side wall, and is distributed internally within the walls of the dilute saline water spacer 35 to holes 630 that enter into the cavity of the dilute saline water spacer 35. The dilute saline water 620 flows from the holes 630 in the far wall of the dilute saline water spacer 35 to like holes 630, not shown, on the opposite side of the dilute saline water spacer 35. After, the dilute saline water enters the holes 630 on the near wall, not shown, it is combined within the dilute saline water spacer 35, exits the dilute saline water spacer 35 in a like manner as the input dilute saline water enters and then out through the long and small cross-sectional area tube 610 as the output dilute saline water 45. The electrical resistance of the dilute saline water in the tubes to ion flow, which is given by the resistivity of the saline water times the tube length divided by the cross-sectional area of the tubes 610 and 640, can be made very high by proper choice of the parameters. If the electrical resistance between any two dilute saline water spacers of the electrodialysis stack is much lower than the electrical resistance of the dilute saline water through the through the tubes 610 and 640 for any desired salinity level, then the salinity of the dilute saline water does not materially affect the desalination as it could in the current traditional construction methods of EDR systems.

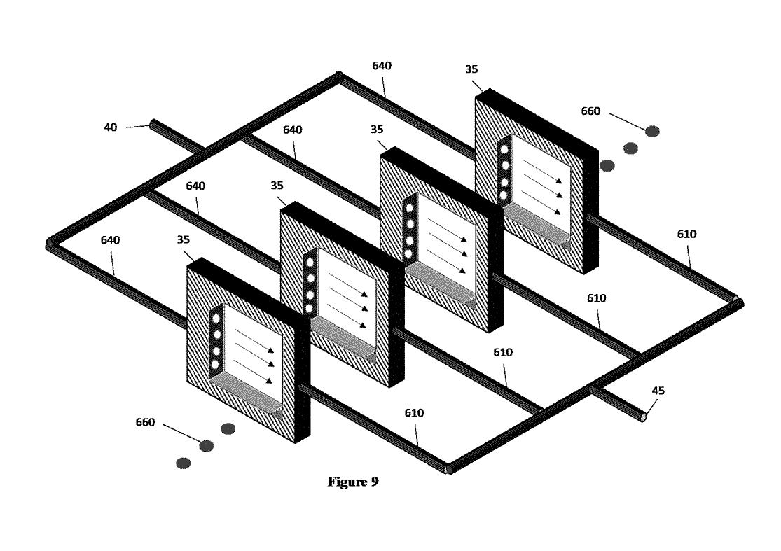

In a modified EDR electrodialysis stack, the dilute saline water 40 and 45 enters and exits multiple identical dilute saline water spacers 35 through long and small cross-sectional area tubes 610 and 640 as shown in FIG. 9. Only the dilute saline water distribution is illustrated. The cation exchange membranes, anion exchange membranes, and the concentrated saline water spacers that would be between each pair of dilute saline water spacers 35 in an electrodialysis stack are not shown. The dotted regions 660 indicates that the arrangement of dilute saline water spacers 35 continue on until the electrode regions of the electrodialysis stack is reached.

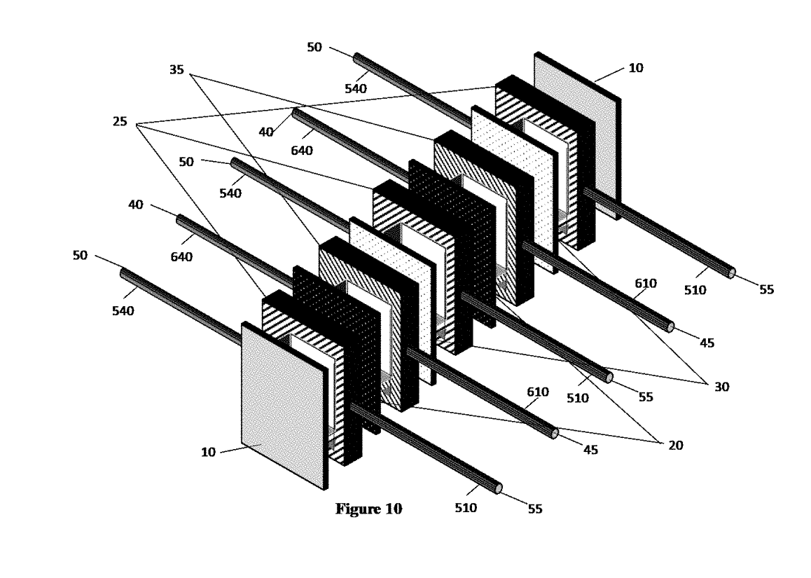

The arrangement of the cation and anion exchange membranes and the concentrated and dilute saline water spacers in this modified EDR system, which is this invention, is shown in FIG. 10. The elements of this invention's electrodialysis stack are: inert electrodes 10, concentrated saline water spacers 25, dilute saline water spacers 35, cation exchange membranes 20, and anion exchange membranes 30. The concentrated saline water 50 enters the thin side of the concentrated saline water spacers 25 through long small cross-sectional area tubes 540, flows through the concentrated saline water spacers 25, and the output concentrated saline water 55 exists out the other thin side of the concentrated saline water spacers 25 through the long small cross-sectional area tubes 510. The dilute saline water 40 enters the thin side of the dilute saline water spacers 35 through long small cross-sectional area tubes 640, flows through the dilute saline water spacers 35, and the output dilute saline water 45 exists out the opposite thin side of the dilute saline water spacers 35 through the long small cross-sectional area tubes 610. The differences in this modified EDR system and the traditional EDR system are: (1) the concentrated and dilute saline waters enter and leave the concentrated and dilute saline water spacers through the thin sides of the concentrated and dilute saline water spacers rather than from front-to-back through the large cross-sectional area side of the spacers and (2) dilute and concentrated saline water is fed or retrieved to and from each concentrated and dilute saline water spacer 25 and 35 respectively through long small cross-sectional area tubes that have a large electrical resistance to ion flow. The pump pressure must increase some to accommodate these long slender tubes. However, the end result is that essentially all the ions will flow through the cation and anion exchange membranes of the electrodialysis stack and little of them will flow through the saline water distributions systems regardless of the salinity concentrations of the feed waters and thus the modified EDR system should operate well regardless of the salinity of the feed waters.

When the electrodialysis stack becomes very long, the electrical resistance through the long small cross-sectional tubes must increase to maintain performance. Given fixed small cross-sectional areas of the tubing, the amount of tubing can be reduced for both the saline water feed through and recirculation cases and yet maintain good performance. One example is that the length of tubing to and from the spacers can be shorter in the central region of the electrodialysis stack than near the ends of the electrodialysis stack. Another example is that the tubing to and from the spacers could be formed in groups as described in the next example. The concentrated saline water distribution system is first discussed. For the feed through case, the input concentrated saline water can first be divided into M long small cross-sectional tubes. The output of each of these M tubes can then again be divided into N long small cross-sectional tubes which feeds N of the N Times M concentrated saline water spacers. The output tubing from the concentrated saline water spacers is constructed in the same manner as the input tubing, but of course, the direction of concentrated saline water flow is reversed. For the concentrated saline water recirculation case, there are M tanks with pumps that hold the recirculating concentrated saline water. The concentrated saline water in each of the M tanks feeds N concentrated saline water spacers through N long small cross-sectional tubes. The total number of concentrated saline water spacers then is N Times M. The dilute saline water distribution system can be constructed in the same manner as the concentrated saline water distribution system just described. These constructions are relevant when the electrodialysis stack is long containing many dilute and concentrated saline water spacers.

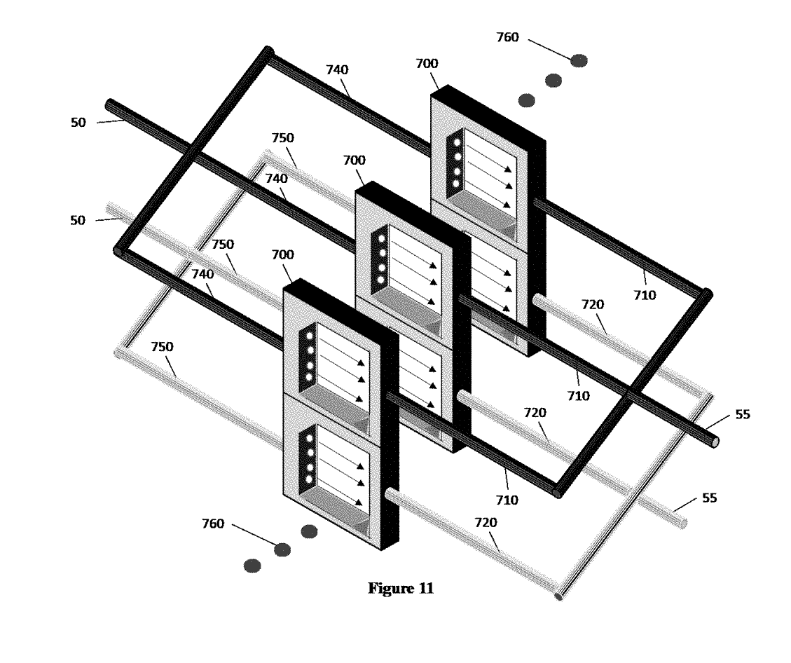

So far, the discussion has been only for a modified EDR system. A variation of the EDR system that forms no gasses at the electrodes is the Capacitive Electrodialysis Reversal CEDR system described in Non-Patent Literature Document [2]. This variation of EDR has independent oppositely directed parallel electrodialysis stacks, supercapacitor electrodes, and there is a variation in the operation. The concept for modifying the spacers and saline water distribution systems of EDR in this invention can also be applied to CEDR. FIG. 11 is similar in form to FIG. 7 where the only difference is that the concentrated saline water flows through two independent thin cavities in the concentrated saline water spacers 700. In a modified electrodialysis stack, the concentrate saline water 50 and 55 enters and exits multiple identical concentrated saline water spacers 700, which have two independent cavities in them, through long and small cross-sectional area tubes 710, 720, 740, and 750 as shown in FIG. 11. Only the concentrated saline water distribution is illustrated in FIG. 11. The cation exchange membranes, anion exchange membranes, and the dilute saline water spacers that would be between each pair of concentrated saline water spacers 700 are not shown in FIG. 11. The dotted regions 760 indicates that the arrangement of concentrated saline water spacers 700 continue on until the supercapacitor electrode regions of the electrodialysis stack is reached. The dilute saline water distribution system is identical to the concentrated saline water distribution system shown in FIG. 11 but is not shown.

This invention could be used to replace the EDR or CEDR systems described in Non-Patent Literature Document [3] so as to highly concentrate the saline waste water for itself or some other desalination system. Because the modified EDR or CEDR systems can operate with any water salinity below saturation, they can also be used as a salt water concentrator rather than a desalination process. Examples are: (1) Concentrate the waste saline water of RO systems to ease the waste disposal problem or (2) be part of a process to make salt. This invention could also be used to supersaturate saline water and form solids as described in Non-Patent Literature Document [4] given the saline water has a metastable zone and precipitation has not yet occurred.

1-7. (canceled)

8. A very high salinity electrodialysis reversal or capacitive electrodialysis reversal devise comprising:
a. an electrodialysis stack that is formed with a stack of separated alternating anion and cation ion exchange membranes having independent low and high salinity water channels located between each alternating pair of anion and cation ion exchange membranes where portions of an electrodialysis system is an example;
b. either conducting or supercapacitor electrodes as found in either electrodialysis reversal or capacitive electrodialysis reversal systems respectively which are capable of absorbing and/or dispensing electrons in the case of electrodialysis reversal or ions in the case of capacitive electrodialysis reversal in the presence of saline water and an electric field;
c. either said very high salinity electrodialysis reversal or capacitive electrodialysis reversal devise composed of a pair of either said conducting or supercapacitor electrodes respectively placed at each end of the said electrodialysis stack and has independent saline water channels separating the said electrodes and said electrodialysis stack;
d. lower and higher saline waters varying in any desired salinities fed through a set of independent long and small cross-sectional area tubes into each of the said independent low and high salinity water channels respectively of the said very high salinity electrodialysis reversal or capacitive electrodialysis reversal devise, and out of each of these said independent low and high salinity water channels through another corresponding set of independent long and small cross-sectional area tubes; and
e. the said sets of independent long and small cross-sectional area tubes carrying low and high salinity water to and from either the said very high salinity electrodialysis reversal or capacitive electrodialysis reversal devise is made so that the saline waters can flow through them so as to feed and retrieve the saline waters to and from each of the said independent low and high salinity water channels of the said very high salinity electrodialysis reversal or capacitive electrodialysis reversal devise but have lengths and cross-sectional areas such that the electrical resistance to ion flow is very high relative to the much lower electrical resistance to ion flow through the said electrodialysis stack as well as through the saline water regions near the electrodes.

9. The said very high salinity electrodialysis reversal or capacitive electrodialysis reversal devise of claim 8 is operated using a desalination/concentration process comprising:
a. the said desalination/concentration process of operating the said very high salinity electrodialysis reversal or capacitive electrodialysis reversal devise is to apply voltages to the said electrodes which causes the ions to flow through the said anion and cation ion exchange membranes as well as through the said low and high salinity water channels so that the saline water in the said low salinity water channels becomes less saline and the saline water in the said high salinity water channels becomes more saline while in the electrodialysis reversal case electrochemical reactions occur at the electrodes so as to maintain current flow and in the capacitive electrodialysis reversal case the ions are absorbed or dispensed at the supercapacitor electrodes to maintain current flow but requires exchanging the locations of the said supercapacitor electrodes between two parallel and identical said capacitive electrodialysis reversal devises every charging and discharging cycle of the said supercapacitor electrodes or exchanging the low and high salinity waters between charging and discharging cycles of the said supercapacitor electrodes using only a said single capacitive electrodialysis reversal devise;
b. during the said desalination/concentration process, nearly all the ions flow through the said electrodialysis stack and the saline water regions near the said electrodes regardless of salinity levels while almost none of the ions flow through the saline water distribution system composed of said sets of independent long and small cross-sectional area tubes connected to and from each of the said low and high salinity water channels as well as each of the saline water regions near the said electrodes because of the high electrical resistance to ion flow of the said saline water distribution system relative to the lower electrical resistance to ion flow of the said low salinity water channels, said high salinity water channels, said anion ion exchange membranes, and said cation ion exchange membranes found in the said electrodialysis stack and the saline water regions near the said electrodes;
c. because almost all the ions flow through the said electrodialysis stack and saline water regions near the electrodes, even for very high salinities, while very few ions flow through the portion of the said saline water distribution systems composed of said sets of independent long small cross-sectional area tubes, very high concentrated saline water can be obtained by this said desalination/concentration process;
d. the said very high salinity electrodialysis reversal or capacitive electrodialysis reversal devise may be operated even with supersaturated saline water as long as this saline water remains in the supersaturated metastable state where spontaneous precipitation has not yet occurred; and
e. the said very high salinity electrodialysis reversal or capacitive electrodialysis reversal devise may be operated even with supersaturated saline water as long as any of the precipitated solids can be filtered out as to not allow the said saline water distributions systems to become clogged with precipitated solids.
